(19) United States
(12) Patent Application Publication
(10) Pub. No.: US 2011/0035291 A1
(43) Pub. Date: Feb. 10, 2011

(54) Method and System for Online Redistribution of Information

(76) Inventors: Donald Jones, Las Vegas, NV (US); Greg Shields, Denver, CO (US)

Correspondence Address: Donald Jones, 280 E Maulding Ave, Las Vegas, NV, 89123, US

(21) Appl. No.: 12/698,722

(22) Filed: Feb. 2, 2010

Related U.S. Application Data
(60) Provisional application No. 61/223,847, filed on Jul. 8, 2009.

(51) Int. Cl. G06Q 30/00; G06Q 10/00

(52) U.S. Cl. 705/26.1; 705/344

(57) ABSTRACT

A method and system includes transmitting a publishing request from a first location, over a network to a central processor. The publishing request at least includes information for electronic publication, where the transmitting adjusts, by a first amount, a first account associated with a first user making the publishing request. At an at least one second location, over the network from the central processor, the publishing request is received for at least one user to accept the request and electronically publish published information including the information. At the at least one second location, over the network from the central processor, validation of the publication is received, where at least a second account associated with the at least one user is credited by a second amount as a result of validation of the publication, wherein a ratio of the first amount and the second amount is a predetermined value.

### CROSS-REFERENCE TO RELATED APPLICATIONS

The present Utility patent application claims priority benefit of the U.S. provisional application for patent Ser. No. 61/223,847 filed on Jul. 8, 2009 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to online information distribution. More particularly, the invention relates to a system of distributing information to online authors and rewarding authors who disseminate the information.

### BACKGROUND OF THE INVENTION

The present invention is a balanced means of distributing news and information to online authors, including authors of Web blogs (blogs) and e-mail newsletters. The system is designed to generally prevent any one person from overburdening the system with input, and to incent participating authors to redistribute information.

Many authors have colleagues who are authors that have similar interests. Many authors also have personal and commercial enterprises and would like to use their network of colleagues, even those they may not have met personally, to distribute information and announcements about said enterprises. Further, many unrelated commercial entities would like to use online authors to distribute commercial information to the authors' audiences. Currently, it is difficult for authors of e-mail newsletters and online blogs to connect with one another to facilitate this distribution of information. Commercial entities likewise find it difficult to contact authors to request the distribution of information. It is therefore an objective of the present invention to provide a solution for enabling online authors and commercial entities to contact other online authors for the distribution of information pertaining to shared interests.

Currently, individuals and entities solve this problem by maintaining mailing lists, typically for e-mail, and by sending out an “e-mail blast” when they have information they wish to share. However, this creates several problems. Mailing lists are rarely categorized in a way that generally ensures that only recipients who are interested in the topic receive the mailing; extra recipients may regard the mailing as spam and may remove themselves or ask to be removed from future mailings. Due to the risk of receiving vast quantities of unwanted mailings, many authors purposely do not disclose their contact information, making them impossible to reach. Also, individuals or entities that need information to be distributed are rarely able to gauge the success of their efforts since, when an author chooses to redistribute information as requested, there is no standardized means for this to be measured. Furthermore, those wishing to distribute information may be willing to offer financial compensation to authors who agree to redistribute the information; however, this can be difficult because most authors would need to be paid as subcontractors, creating enough paperwork and overhead to make offering such compensation impractical. Many current systems that seek to share information between a pool of topically related authors do so with no regard for the ability of one person to take undue advantage of the system. This results in a small number of information suppliers over-utilizing the system, which may also result in many authors disengaging from the system and reducing the effectiveness of the system.

In view of the foregoing, there is a need for improved techniques for connecting online authors and other entities for the sharing of information about similar interests that manages the necessary connections in a way that discourages or prevents abuse of the system by any one person or entity and that encourages and rewards authors for their participation.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary system and process for submitting information to online authors in order to redistribute the information, according to an embodiment of the present invention;

FIG. 2 illustrates an exemplary system and process for submitting information to online authors in order to redistribute the information that allows for the financial compensation of the redistributing authors, according to an embodiment of the present invention; and

FIG. 3 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a method and system for online redistribution of information is presented.

In one embodiment a method includes steps for transmitting a publishing request for electronic publication of information, where a first account is adjusted by a first amount. Steps receive the publishing request for at least one user to accept the request and electronically publish published information including the information. Steps receive validation of the publication, where at least a second account is credited by a second amount as a result of validation of the publication, wherein a ratio of the first amount and the second amount is a predetermined value.

In another embodiment a method includes the steps of transmitting a publishing request from a first location, over a network to a central processor. The publishing request at least includes information for electronic publication, where the transmitting adjusts, by a first amount, a first account associated with a first user making the publishing request. At an at least one second location, over the network from the central processor, the publishing request is received for at least one user to accept the request and electronically publish published information including the information. At the at least one second location, over the network from the central processor, validation of the publication is received, where at least a second account associated with the at least one user is credited by a second amount as a result of validation of the publication, wherein a ratio of the first amount and the second amount is a predetermined value. In another embodiment the published information further includes a token for validation of the publication. In yet other embodiments the publishing request further includes category information and the at least one second location is associated with the category information. In still other embodiments the first amount includes points, the first account is adjusted by debiting the first amount and the second amount includes points. In other embodiments the publishing request further includes a total monetary amount the first user agrees to pay for a plurality of the published information, the first amount includes the total monetary amount and the first account is adjusted by crediting the first amount. In yet other embodiments the publishing request further includes a maximum monetary amount the first user agrees to pay for the published information, the second amount is less than or equal to the maximum monetary amount and the first account is debited by the second amount.

In another embodiment a system includes means for transmitting a publishing request from a first location, over a network to a central processor. The publishing request at least includes information for electronic publication, where the transmitting means adjusts, by a first amount, a first account associated with a first user making the publishing request. The system includes means for receiving at an at least one second location, over the network from the central processor, the publishing request for at least one user to accept the request and electronically publish published information including the information. The system further includes means for receiving at the at least one second location, over the network from the central processor, validation of the publication, where at least a second account associated with the at least one user is credited by a second amount as a result of validation of the publication, wherein a ratio of the first amount and the second amount is a predetermined value. In another embodiment the published information further includes a token for validation of the publication. In yet other embodiments the publishing request further includes category information and the at least one second location is associated with the category information. In still other embodiments the first amount includes points, the first account is adjusted by debiting the first amount and the second amount includes points. In other embodiments the publishing request further includes a total monetary amount the first user agrees to pay for a plurality of the published information, the first amount includes the total monetary amount and the first account is adjusted by crediting the first amount. In yet other embodiments the publishing request further includes a maximum monetary amount the first user agrees to pay for the published information, the second amount is less than or equal to the maximum monetary amount and the first account is debited by the second amount.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Preferred embodiments of the present invention provide a Web site that is designed to collect news and information from individuals, including, but not limited to, online authors, who wish to distribute that information across the Internet and via email. Said information may include, without limitation, such things as press releases, announcements, etc. Based on categories and keywords, preferred embodiments of the present invention identify authors who may have an interest in the submitted information based upon the interests of the audience that said authors typically write for, thus connecting the content with the authors who can best distribute it. Preferred embodiments of the present invention then track the authors who distribute the information and reward them with the ability to later distribute their own information through the Web site. In other words, taking information from the Web site and distributing it earns one the ability to later submit information to the Web site for distribution by others. Preferred embodiments of the present invention also enable use by individuals who are not themselves authors and who have no means of earning the ability to submit information. These individuals instead may submit payment. This payment is then distributed to the authors who redistribute the submitted information. Preferred embodiments of the present invention also enable information submitters to target authors not only by topic but also by the reach of the author (i.e., the size of the author's audience). In preferred embodiments the author's reach is calculated based upon a number of criteria such as, but not limited to, the number of readers who subscribe to the author's syndicated blog feed or visit the author's blog Web site, the number of recipients of the author's e-mail newsletter, etc.

Preferred embodiments of the present invention provide the following solutions for problems with the prior art. Preferred embodiments generally ensure that the information is only sent to recipients who are interested in it by allowing authors to self-categorize their interests, by only including authors on notifications having to do with their categories, and by allowing authors to pull notifications from a central system rather than having the notifications pushed via mailings. Preferred embodiments do not require authors to divulge their contact information, so they retain a sense of privacy while gaining the ability to learn of new information that may interest their audience. Preferred embodiments automatically track the publishing activity of participating authors. This enables information-distribution campaigns to be measured for effectiveness. In order to make the financial compensation of authors who agree to redistribute information practical, preferred embodiments offer a central market place for authors, enabling information providers to supply a pool of money from which participating authors may be paid. To generally prevent one user from taking undue advantage of the system, preferred embodiments create an economy where only the authors who distribute significant amounts of information can submit information for distribution. This creates limits based on participation.

Preferred embodiments of the present invention may be used by any sufficiently large pool of authors and information providers who share one or more topical interests, particularly within major areas of commerce such as, but not limited to, food and beverage, clothing, consumer electronics, information technology, and so forth. However, any category that has a large number of independent authors may potentially be used as a topical interest such as, but not limited to, sports, entertainment, health and fitness, pets, etc., and any category which also has a large number of commercial entities who conduct marketing campaigns is also especially likely to be used as a topical interest such as, but not limited to, automobiles, cosmetics, appliances, etc.

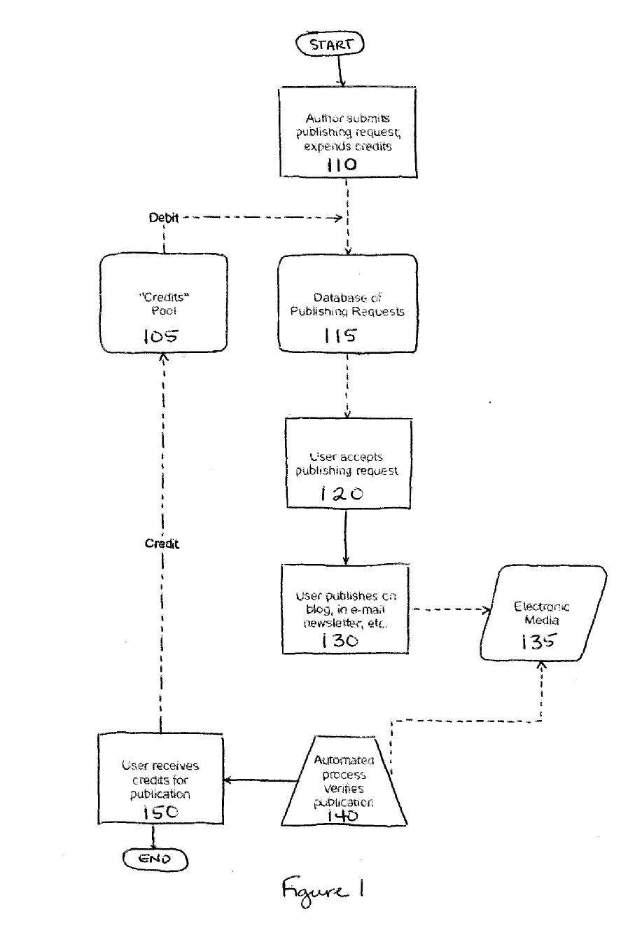

FIG. 1 illustrates an exemplary system and process for submitting information to online authors in order to redistribute the information, according to an embodiment of the present invention. The present embodiment is a balanced system for one user to request that other users republish information. The system awards points to authors who distribute information provided by the system and requires the expenditure of points in order to submit information for distribution. The ratio of points (i.e., how many are awarded for publishing information versus how many points are required to submit information) is controlled by the operator of the system, thus establishing an economy. Ideally this works by means of a Web site where users create accounts for themselves; however, alternate environments may be used to create the system such as, but not limited to, standalone computer software applications that communicate with a central database or data store, etc. In the present embodiment, each account is assigned a certain number of points in an account in a credit pool 105 upon creation, which is configurable by the operator. At the start of the process in step 110, a user of the system submits a publishing request including the information that they want to be published to a database of publishing requests 115. In order to submit the request, the user must expend credits from their account in credit pool 105. A cost, in credits, is established by the operator of the system for the privilege of submitting information to be distributed. For the purpose of illustration in one example, a user may expend ten credits to submit one publishing request; however, any number of credits may be required to submit a publishing request. In step 120 other users of the system receive the publishing request and may choose to accept the publishing request. Upon doing so, the other users publish the requested information in their own electronic media 135 for example, without limitation, blogs, e-mail newsletters, Twitter, and so forth. In step 140 an automated process continually checks users' registered electronic media 135, and detects when publishing requests have been completed. The system credits users who have been verified as completing a publishing request in step 150. Authors who have verifiably distributed the information are awarded a configurable number of points, which is set by the operator of the system. For example, without limitation, each user might receive 1 credit for completing one publishing request. The credits awarded to the user are credited to the user's account in credit pool 105.

In the present embodiment, the system comprises means of automatically verifying the publication of information in electronic media 135, as shown by way of example in step 140. An author who indicates his wish to participate in a particular information distribution request is provided with a token that the author includes in his writings. This token may take the form of an Internet URL. The token might also take other forms, including but not limited to, Internet Web browser “cookies.” To verify the publication of information in Web and email forms on HTML-based Web sites, the verification process is preferably done by an automated computer program that retrieves the HTML content of a Web site and parses it for the tokens that are provided to the author by the system. To verify the publication of information in XML-based documents, including, but not limited to, RSS feeds, the verification process is preferably done by an automated computer program that retrieves the document content over the Internet and parses it for the tokens that were provided to the author by the system. To verify the publication of information in text or HTML formatted e-mail messages such as, but not limited to, e-mail newsletters, the verification process is preferably done by requiring authors to include a predefined e-mail address in the mailing list. Then, an automated computer program retrieves the e-mail content from that predefined mailbox and parses the email for the tokens that were provided to the author by the system. Verification of publication might also be accomplished by other means, including but not limited to parsing the content of the publication and following Internet URLs to discover which URLs, if any, lead to the desired Web site.

In the present embodiment, users of the system may define categories which help indicate what audiences their publishing efforts reach. For example, without limitation, users may categorize themselves as reaching audiences for electronics goods, food items, and so forth. Authors or advertisers who submit publishing requests can then target only those users in desirable categories; for example, without limitation an author might only want a publishing request to go to users in the electronics goods category. In the present embodiment, multiple categories can be defined for a single system or implementation, or a separate system or implementation could be used for different categories. Categories might also be further divided into sub-categories to any number of sub-levels. In other embodiments, authors or advertisers who submit publishing requests can specify the type of electronic media for publication such as, but not limited to, blogs, e-mail newsletters, Twitter, and so forth, or may specify all media.

The following is a functional example of how the present embodiment typically works. Annie submits a press release to the system's Web site, step 110. The press release describes a new candy product Annie asks that the press release be distributed to audiences interested in candy by selecting the appropriate interest categories and/or keywords Annie's user account on the system's Web site is debited a certain number of points, step 110, indicating her use of the system to submit information. Bob, Carl, and Don are all authors who write about candy and other food-related topics. Bob, Carl and Don are notified by the Web site that a new story is available that relates to their food interests. Bob, Carl, and Don review the story on the Web site and believe that the story would be interesting to their audiences, step 120. Bob, Carl and Don each compose articles based upon the information submitted by Annie and publish those articles in their respective venues, such as, but not limited to, blogs, step 130. Bob, Carl, and Don indicate on the Web site that they have distributed the information submitted by Annie The Web site confirms the publication of the information by Bob, Carl, and Don, step 140, and awards them points for having published the information, step 150. Bob, Carl, and Don now possess points in their accounts. By publishing additional information submitted to the Web site, Bob, Carl and Don will eventually accumulate enough points to enable them to submit their own information to the Web site.

An alternate embodiment may comprise means for incorporating commercial submission of information with financial consideration rather than the use of points for submissions. This embodiment includes, without limitation, a pool of money into which information submitters pay money and from which publishing authors are paid. Information submitters may specify a maximum per-author payment amount. When an author accepts an offer for publication, he includes a requested fee for publication. The system then approves or declines the author offers based upon their requested fee and the remaining funds in the submitter's money pool. Ideally, the present embodiment works by means of a Web site that can accept payments, track author offers to publish information, and remit payment to authors who verifiably complete their agreement to publish information; however, alternate environments may be used to create the system such as, but not limited to, standalone computer software applications, telephone-based voice response systems, etc.

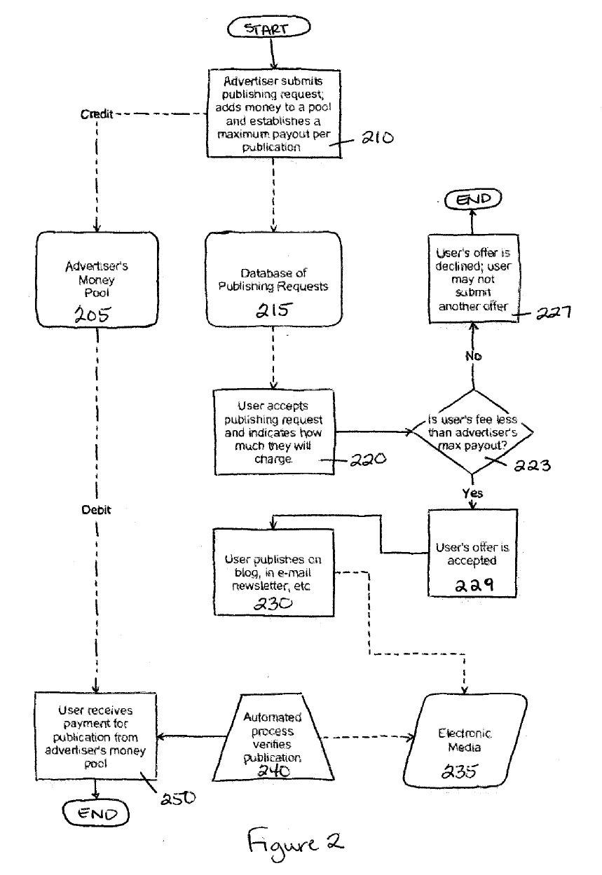

FIG. 2 illustrates an exemplary system and process for submitting information to online authors in order to redistribute the information that allows for the financial compensation of the redistributing authors, according to an embodiment of the present invention. In the present embodiment, the system enables advertisers, who do not personally have credits within the system, to submit publishing requests by offering to pay users for publications by paying money into an advertiser's money pool 205. The process starts at step 210 where an advertiser submits a publishing request into a database of publishing requests 215 and provides a pool of money to be paid into money pool 205. In step 210 the advertiser also establishes a maximum payout for each publication. Users are then notified of the request. In step 220, users may accept the request, and in doing so must indicate the amount of money they want to receive in exchange for publishing the information as requested. In step 223 it is determined if the user's fee is less than the maximum payout indicated by the advertiser in step 210. If the fee requested by the user is less than or equal to the advertiser's maximum payout, the user's offer is accepted in step 229. Otherwise, the user's offer is declined in step 227, and the user may not submit another offer. In some alternate embodiments, authors may be able to submit multiple offers. In the present embodiment, the system accepts or rejects offers in the order in which the offers are received; however, in alternate embodiments the offers may be considered in orders based on different criteria such as, but not limited to, the amount of the user's fee, the author's reach, etc. Furthermore, in some alternate embodiments, authors do not submit offers, and instead the advertiser indicates how much they will pay for each publication, and the first authors to accept the advertiser's offer are allowed to publish the information. In the present embodiment in step 230, users publish the requested information in their own electronic media 235, for example, without limitation, blogs, e-mail newsletters, Twitter, and so forth. In step 240 an automated process continually checks users' registered electronic media 235, and detects when publishing requests have been completed. The system then pays those users for completing the publishing request in step 250 by taking money in the amount of the requested fee from advertiser's money pool 205. Users who complete publishing requests may also receive credits in their accounts with the system that enable them to submit their own information for publication.

The following is a functional example of how the present embodiment typically works. In the present example, Ellen submits an announcement to the system's Web site, step 210. The announcement describes a new clothing product. Ellen is not an author, and has not earned any points with the system, nor does she have the prospect for earning points in the future. Instead, she submits a payment of $100, step 210. Ellen also specifies a maximum of $5 for each placement of her announcement, step 210. Frank, George, and Harold are all authors who write about clothing. Frank, George and Harold are notified by the Web site that a new story is available that relates to their clothing interests. They are also informed that payment is available for authors who choose to write about Ellen's announcement. Frank, George, and Harold use the Web site to indicate their interest in writing about Ellen's story, step 220. They are each asked for the dollar amount that they would charge to write about this story. Frank responds with $10. George responds with $3. Harold responds with $5. The Web site accepts or declines each author's offer based on the amount of money remaining in Ellen's $100 payment and based on Ellen's maximum per-placement amount of $5. Frank's offer is declined, as it exceeds the $5 maximum, step 227. Frank may not submit another offer. George's offer is accepted and Ellen's $100 account is reduced by $3, step 229. That $3 is placed into a holding account for George. Harold's offer is accepted and Ellen's $95 account is reduced by $5, step 229. That $5 is placed into a holding account for Harold. The Web site confirms the publication of the information by George and Harold, step 240, and schedules them for payment of $3 and $5, respectively, step 250. George and Harold are also awarded points on the Web site, which they can accumulate to enable the submission of their own information in the future.

Some embodiments of the present invention may also comprise an automated process that uses various means to determine the reach of each user's electronic media. For example, without limitation, the process may query a statistics database to determine the number of readers who receive an e-mail newsletter or the number of readers who regularly visit a blog. Some embodiments may allow authors to manually provide this information, while other embodiments might have this information provided manually by a researcher assigned to discover these statistics. This process would be repeated on a regular basis so that the statistics remain up-to-date. Authors and advertisers may then restrict their publishing requests to only those users whose electronic media have some minimum reach or audience size. The process may determine the traffic of an HTML Web site based upon objective third-party reports with third-party data delivered via e-mail in various formats or via Web services. This is preferably done by retrieving traffic data from an agreed-upon independent source of Web site statistics. This must be a source that the author uses and which can provide aggregate statistics either by e-mailing a document or by exposing a Web-based service or application. The system may receive the e-mailed information and parse it for the needed statistics, including, but not limited to, hit counts and other data, or may connect to the Web service or application and request the needed statistics. The process may also determine the traffic of an XML document such as, but not limited to, an RSS feed based upon third-party reports. This is preferably done by retrieving traffic data from an agreed-upon independent source of document statistics. This is typically a document-republishing service, which takes the author's XML document and makes it available through trackable means and which can provide aggregate statistics on document access and use either by e-mailing a document or by exposing a Web-based service or application. The system may receive the e-mailed information and parse it for the needed statistics, including, but not limited to, hit counts and other data, or may connect to the Web service or application and request the needed statistics.

The following is a functional example of how the present embodiment typically works. In the present example, Iris submits an announcement to the system's Web site. The announcement describes a new automobile accessory. Iris is not an author, and has not earned any points with the system, nor does she have the prospect for earning points in the future. Instead, Iris submits a payment of $50. Iris also specifies a maximum of $25 for each placement of her announcement. Iris specifies that only authors with a reach of at least 100 be allowed to participate. John, Keith, Lou, Mark, and Neil are all authors who write about automotive accessories. John has a reach of 250. Keith has a reach of 92. Lou has a reach of 180. Neil has a reach of 500. John, Lou, and Neil are notified by the Web site that a new story is available that relates to their automotive interests. They are also informed that payment is available for authors who choose to write about Iris' announcement. Keith is not notified because he does not have sufficient reach, as identified by the Web site. John, Lou, and Neil use the Web site to indicate their interest in writing about Iris' story. They are each asked for the dollar amount they would charge to write about this story. John responds with $25. Lou responds with $20. Neil responds with $20. The Web site accepts or declines each author's offer based on the amount of money remaining in Iris' $50 payment and Iris' maximum per-placement amount of $25. John's offer is accepted, and $25 of Iris' $50 is placed on hold. Lou's offer is accepted, and $20 of Iris' remaining $25 is placed on hold. Neil's offer is declined, because only $5 of Iris' money remains. Neil may not submit another offer. In this example, the offers are considered in the order in which they are received; however, in alternate embodiments where the offers are considered based on different criteria, the process may differ. For example, without limitation, if an embodiment that considers offers based on the amount of the user's fee, Lou and Neil's offers of $20 would be considered and accepted first, and John's offer of $25 will be declined because only $10 of Iris' money remains. In an embodiment that considers offers based on the author's reach, Neil's offer of $20 is considered and accepted first because his reach of 500 is the highest. Then, John's offer of $25 is considered and accepted since his reach of 250 is next in order. Finally, Lou's offer of $20 is considered and declined because only $5 of Iris' money remains. In the present example, The Web site confirms the publication of the information by John and Lou and schedules them for payment of $25 and $20, respectively. John and Lou are also awarded points on the Web site, which they can accumulate to enable the submission of their own information in the future.

In alternate embodiments of the present invention, the Web site may have a public area where visitors to the Web site may browse the categories and sub-categories and view the information articles that have been submitted for publication. The information articles may also include the date of submission enabling a person to determine how “new” or “fresh” an article is. In other alternate embodiments, a visitor can sort the articles within a category by date. In yet other embodiments, the visitor may be able to request a list of all articles within a given time period such as, but not limited to, the last day, week, month, etc. During the time the visitor is browsing the article, the visitor would be provided information about the purpose of the Web site and encouraged to register. Registration to view the articles would not be required since the articles are meant for public distribution. In another embodiment the amount of times an article is viewed is tracked. This tracking information would be available to the registered users. In a non-limiting example, this would let an author see which articles were getting the most attention and aid in deciding which to include in a published article. In another embodiment an author that submits a popular article, as gauged by the amount of public views, may be rewarded by being credited a fixed number of points. The points could be used to request additional publications. In the instance of an advertiser submitted article, in which a monetary amount was provided with the publication request, the advertiser would not be rewarded. In embodiments where views of the articles are tracked, various means such as, but not limited to, IP tracking, cookies, etc. would be used to count unique views and not count multiple views from one person abusing the system.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

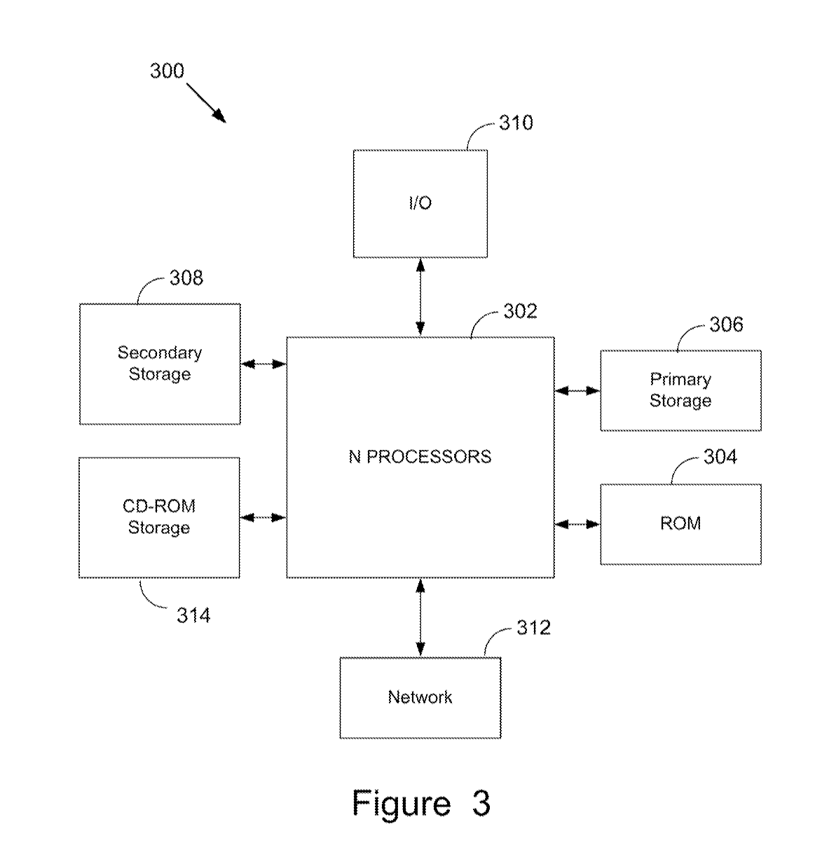

FIG. 3 illustrates a typical computer system that, when appropriately configured or designed, can serve as a computer system in which the invention may be embodied. The computer system 300 includes any number of processors 302 (also referred to as central processing units, or CPUs) that are coupled to storage devices including primary storage 306 (typically a random access memory, or RAM), primary storage 304 (typically a read only memory, or ROM). CPU 302 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 304 acts to transfer data and instructions uni-directionally to the CPU and primary storage 306 is used typically to transfer data and instructions in a bi-directional manner. Both of these primary storage devices may include any suitable computer-readable media such as those described above. A mass storage device 308 may also be coupled bi-directionally to CPU 302 and provides additional data storage capacity and may include any of the computer-readable media described above. Mass storage device 308 may be used to store programs, data and the like and is typically a secondary storage medium such as a hard disk. It will be appreciated that the information retained within the mass storage device 308, may, in appropriate cases, be incorporated in standard fashion as part of primary storage 306 as virtual memory. A specific mass storage device such as a CD-ROM 314 may also pass data uni-directionally to the CPU.

CPU 302 may also be coupled to an interface 310 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 302 optionally may be coupled to an external device such as a database or a computer or telecommunications or internet network using an external connection as shown generally at 312, which may be implemented as a hardwired or wireless communications link using suitable conventional technologies. With such a connection, it is contemplated that the CPU might receive information from the network, or might output information to the network in the course of performing the method steps described in the teachings of the present invention.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing novel means for and/or steps described that the applications designer will selectively decide, depending upon the practical considerations of the particular implementation, to carry out and/or locate within the jurisdiction of the USA. For any claims construction of the following claims that are construed under 35 USC §112 (6) it is intended that the corresponding means for and/or steps for carrying out the claimed function also include those embodiments, and equivalents, as contemplated above that implement at least some novel aspects and objects of the present invention in the jurisdiction of the USA. For example, the gathering of statistics related to authors' reach, and/or the automated verification of publication by parsing publications' text, may be performed and/or located outside of the jurisdiction of the USA while the remaining method steps and/or system components of the forgoing embodiments are typically required to be located/performed in the US for practical considerations.

Having fully described at least one embodiment of the present invention, other equivalent or alternative methods of providing an online information redistribution system according to the present invention will be apparent to those skilled in the art. The invention has been described above by way of illustration, and the specific embodiments disclosed are not intended to limit the invention to the particular forms disclosed. For example, the particular implementation of the system may vary depending upon the particular type of users. The users described in the foregoing were directed to online authors; however, similar techniques are to distribute information to users other than authors for redistribution. For example, without limitation, product suppliers may use an online redistribution system to provide information to retailers who sell their products to be redistributed on the sellers' Web sites. Other examples of users who may use information redistribution systems according to the present invention may include, without limitation, a company headquarters and satellite offices, franchisers and franchisees, hospitals and other health centers and doctors, etc. Implementations of the present invention for use by persons other than authors are contemplated as within the scope of the present invention. The invention is thus to cover all modifications, equivalents, and alternatives falling within the spirit and scope of the following claims.

Claim elements and steps herein have been numbered and/or lettered solely as an aid in readability and understanding. As such, the numbering and lettering in itself is not intended to and should not be taken to indicate the ordering of elements and/or steps in the claims.

What is claimed is:

1. A method comprising:
steps for transmitting a publishing request for electronic publication of information, where a first account is adjusted by a first amount;
steps for receiving said publishing request for at least one user to accept said request and electronically publish published information comprising said information;
steps for receiving validation of said publication, where at least a second account is credited by a second amount as a result of validation of said publication, wherein a ratio of said first amount and said second amount is a predetermined value.

2. A method comprising the steps of:
transmitting a publishing request from a first location, over a network to a central processor, said publishing request at least comprising information for electronic publication, where said transmitting adjusts, by a first amount, a first account associated with a first user making said publishing request;
receiving at an at least one second location, over the network from said central processor, said publishing request for at least one user to accept said request and electronically publish published information comprising said information;
receiving at said at least one second location, over the network from said central processor, validation of said publication, where at least a second account associated with said at least one user is credited by a second amount as a result of validation of said publication, wherein a ratio of said first amount and said second amount is a predetermined value.

3. The method as recited in claim 2, wherein said published information further comprises a token for validation of said publication.

4. The method as recited in claim 2, wherein said publishing request further comprises category information.

5. The method as recited in claim 4, wherein said at least one second location is associated with said category information.

6. The method as recited in claim 2, wherein said first amount comprises points and said first account is adjusted by debiting said first amount.

7. The methods as recited in claim 6, wherein said second amount comprises points.

8. The method as recited in claim 2, wherein said publishing request further comprises a total monetary amount said first user agrees to pay for a plurality of said published information.

9. The method as recited in claim 8, wherein said first amount comprises said total monetary amount and said first account is adjusted by crediting said first amount.

10. The method as recited in claim 9, wherein said publishing request further comprises a maximum monetary amount said first user agrees to pay for said published information.

11. The method as recited in claim 10, wherein said second amount is less than or equal to said maximum monetary amount and said first account is debited by said second amount.

12. A system comprising:
means for transmitting a publishing request from a first location, over a network to a central processor, said publishing request at least comprising information for electronic publication, where said transmitting means adjusts, by a first amount, a first account associated with a first user making said publishing request;
means for receiving at an at least one second location, over the network from said central processor, said publishing request for at least one user to accept said request and electronically publish published information comprising said information;
means for receiving at said at least one second location, over the network from said central processor, validation of said publication, where at least a second account associated with said at least one user is credited by a second amount as a result of validation of said publication, wherein a ratio of said first amount and said second amount is a predetermined value.

13. The system as recited in claim 12, wherein said published information further comprises a token for validation of said publication.

14. The system as recited in claim 12, wherein said publishing request further comprises category information.

15. The system as recited in claim 14, wherein said at least one second location is associated with said category information.

16. The system as recited in claim 12, wherein said first amount comprises points and said first account is adjusted by debiting said first amount.

17. The system as recited in claim 16, wherein said second amount comprises points.

18. The system as recited in claim 12, wherein said publishing request further comprises a total monetary amount said first user agrees to pay for a plurality of said published information.

19. The system as recited in claim 18, wherein said first amount comprises said total monetary amount and said first account is adjusted by crediting said first amount.

20. The system as recited in claim 19, wherein said publishing request further comprises a maximum monetary amount said first user agrees to pay for said published information, said second amount is less than or equal to said maximum monetary amount and said first account is debited by said second amount.
